(19) United States
(12) Patent Application Publication
(10) Pub. No.: US 2026/0178330 A1
(43) Pub. Date: Jun. 25, 2026

(54) Selective Data Compression for Non-Critical Memory Requests

(71) Applicant: Advanced Micro Devices, Inc., Santa Clara, CA (US)

(72) Inventors: Moumita Dey, San Jose, CA (US); Varun Agrawal, Westford, MA (US); Jagadish B. Kotra, Austin, TX (US)

(73) Assignee: Advanced Micro Devices, Inc., Santa Clara, CA (US)

(21) Appl. No.: 18/991,188

(22) Filed: Dec. 20, 2024

(51) Int. Cl. G06F 9/30; G06F 9/355

(52) U.S. Cl. CPC G06F 9/30047; G06F 9/355

(57) ABSTRACT

Selective data compression for non-critical memory requests is described. In accordance with the described techniques, memory request packets are generated and communicated for retrieval of data from computer memory, and data packets including the retrieved data are communicated to a hardware compression engine. The compression engine selectively compresses the retrieved data and the compressed data is communicated through an interconnect architecture for decompression by a decompression engine. The compression of the data decreases communication congestion within the interconnect architecture. The memory request packets are configurable to include metadata providing hints to the compression engine to guide selective compression of data.

### BACKGROUND

In computing devices, cache prefetching is employed to reduce a delay associated with retrieving data from memory. Prefetch requests are used to load data from memory to a cache when a prefetcher predicts that the data will be utilized in the future by a processor . Due to influences such as the data communication path between the cache and the processor being shorter than the path between the processor and the memory, differences in clock speeds, and widths of interconnect paths, prefetching the data can increase a speed of providing the data to the processor when the processor performs operations that utilize the data.

### BRIEF DESCRIPTION OF THE DRAWINGS

FIG. 1 is a block diagram of a non-limiting example system to implement selective data compression for non-critical memory requests.

FIG. 2 depicts another non-limiting example system to implement selective data compression for non-critical memory requests.

FIG. 3 depicts a procedure in an example implementation of selective data compression for non-critical memory requests.

FIG. 4 depicts a procedure in an example implementation of generating a compression indicator for selective data compression for non-critical memory requests.

FIG. 5 depicts a procedure in an example implementation of compressing or bypassing data via a compression engine for selective data compression for non-critical memory requests.

FIG. 6 depicts a procedure in an example implementation of utilizing a historical compressibility of data for selective data compression for non-critical memory requests.

FIG. 7 depicts a block diagram of a processing system configured to execute one or more applications, in accordance with one or more implementations.

### DETAILED DESCRIPTION

Computing devices, such as personal computers, include components such as processors, physical memory, and caches in electronic communication with each other to support communication of data between the components. For example, a computing device may employ one or more processors for execution of instructions and tasks related to workloads and applications, such as computer software.

In order to support such operations, data stored in the physical memory of the computing device may be retrieved and communicated to the processors. In some situations, data is additionally or alternatively stored in one or more caches of the computing device. The caches are often located closer to the processors and thus are able to provide data to the processors in a shorter amount of time compared to providing the data to the processors from the memory. Further, the caches may be configured to operate with higher data communication speeds than the physical memory.

One example approach to increase the speed at which data is communicated to the processors is prefetching the data from memory and storing the data in a cache responsive to a prediction that the data will be subsequently used by the processors.

Although prefetching data from memory to store the data to the caches can reduce delays associated with providing the data to processors, the process of prefetching data increases communication traffic between the prefetchers, the memory, and other components. A high amount of communication of data from the memory to the prefetchers can result in a data queue at the interconnects. While queued, data associated with a given prefetch request can be delayed from being received at a cache until other prefetch requests have been completed. This can result in a lower speed of communication of the data through the interconnects than expected, and thereby also impact overall performance.

Further, the interconnects often experience a mix of traffic that includes communication of data associated with prefetch requests as well as data associated with demand requests. A demand request can occur responsive to a cache miss, e.g., an event in which an attempt is made to retrieve data from a cache while the data is not stored in the cache. In some situations, the data associated with the demand request may be critical to a workload executed by the processor. Thus, it is desirable to provide the data to the processor from the memory as quickly as possible in order to reduce delays in the execution of the workload.

According to the techniques described herein, a hardware compression engine is employed to compress data retrieved from the memory in order to alleviate memory bottlenecks, which can in turn decrease an amount of time associated with communicating the data through the interconnects. In particular, the compression engine reduces a size of the data by way of the compression. The compression of the data effectively increases a bandwidth of the memory, which in turn may alleviate congestion in various interconnect queues. As a result, overall data access latency can be decreased. Congestion refers to, for example, the queuing of the data communications as described above.

Selective data compression for non-critical memory requests is implemented through use of the compression engine and metadata included in memory request packets. For example, a memory request packet includes a memory request (e.g., a request for retrieval of data from the memory) and metadata associated with the memory request. The memory request is executed in order to retrieve data from the memory, and a data packet is generated that includes the retrieved data and the metadata. The data packet is provided to the compression engine, and the compression engine determines whether to compress the data included in the data packet based on a content of the metadata.

In implementations, the metadata includes a compression indicator and an origin indicator. A value of the compression indicator is used by the compression engine to determine whether the data included in the data packet should be compressed prior to communication of the data through the interconnects. Further, the compression engine employs logic to determine whether to override the compression indicator to bypass compression of the data responsive to one or more conditions. For example, in a situation in which the value of the compression indicator instructs the compression engine to compress the data, the compression engine can selectively override the instruction and bypass compression of the data based on the origin indicator and/or other information according to the techniques described herein. Thus, instead of compressing all data retrieved from the memory, the compression engine selectively identifies data to be compressed based on the metadata to increase efficiency and performance of the computing device.

In some implementations, the selective identification of data to be compressed by the compression engine results in compression of data associated with prefetch requests while bypassing compression of data associated with demand requests. The compression engine is additionally employable to compress data associated with demand requests if certain conditions are satisfied, such as identifying a request associated with a workload or application having a high memory level parallelism (MLP). The high memory level parallelism may indicate that the particular demand request can tolerate the additional time used to compress the data without resulting in a reduction of performance of a processor that receives the data.

In this way, the compression engine reduces congestion associated with communicating data through the interconnects. The compression of the non-critical requests effectively increases a bandwidth or capacity of the interconnects to support concurrent data communications. Thus, data associated with demand requests is able to be communicated through the interconnects without queuing or other delays. This enables the data associated with the demand requests to more quickly and reliably reach one or more processors of the device, thereby reducing latency and increasing device responsiveness.

In some aspects the techniques described herein relate to a computing device including a cache and a hardware prefetcher associated with the cache. The hardware prefetcher is configured to generate metadata associated with a memory request and generate a memory request packet including the memory request and the metadata. The computing device includes a memory controller configured to communicate a data packet to a hardware compression engine responsive to execution of the memory request. The data packet includes the metadata and data retrieved from a physical memory. The hardware compression engine is configured to receive the data packet, determine a compressibility of the data based on the metadata, and control communication of the data through an interconnect architecture based on the compressibility.

In some aspects the techniques described herein relate to a computing device wherein the hardware compression engine is further configured to compress the data responsive to detecting that a condition of the metadata has been satisfied and bypass compression of the data responsive to detecting that the condition has not been satisfied.

In some aspects the techniques described herein relate to a computing device wherein the hardware compression engine is configured to bypass compression of the data by communicating the data through the interconnect architecture to the cache associated with the hardware prefetcher without compressing the data.

In some aspects the techniques described herein relate to a computing device wherein the hardware compression engine is configured to communicate the compressed data through the interconnect architecture to a decompression engine.

In some aspects the techniques described herein relate to a computing device wherein the hardware prefetcher generates the metadata based on a request history associated with the hardware prefetcher, with the request history describing prefetch memory requests promoted to demand memory requests. The hardware prefetcher is configured to determine a frequency of promotion of the prefetch memory requests based on the request history, compare the frequency to a threshold frequency, and set a value of a compression indicator in the metadata based on a difference between the frequency and the threshold frequency.

In some aspects the techniques described herein relate to a computing device wherein the hardware compression engine is configured to compress the data based on the compressibility. For example, the hardware compression engine determines the compressibility of the data based on the data and a hardware compression algorithm. The computing device further includes a decompression engine separated from the hardware compression engine by the interconnect architecture. The decompression engine is configured to receive the data compressed by the hardware compression engine and decompress the data.

In some aspects the techniques described herein relate to a computing device wherein the hardware compression engine is further configured to determine the compressibility based on a memory level parallelism (MLP) associated with the memory request and described by the metadata.

In some aspects the techniques described herein relate to a computing device wherein the memory request is a prefetch memory request generated by the hardware prefetcher for the cache.

In some aspects the techniques described herein relate to a computing device wherein the hardware compression engine is configured to determine the compressibility of the data based on historical compressibility data associated with memory requests from the hardware prefetcher.

In some aspects the techniques described herein relate to a computing device wherein the hardware prefetcher generates the metadata based on an address of the physical memory associated with the memory request and specified by the memory request.

In some aspects the techniques described herein relate to a computing device wherein the compression engine is configured to update a compressibility history associated with the hardware prefetcher based on the amount by which the data was compressed.

In some aspects the techniques described herein relate to a system including a physical memory and a memory controller in communication with the physical memory. The memory controller is configured to receive memory requests and generate data packets including data retrieved from the physical memory based on the memory requests. The system further includes a compression engine in communication with the memory controller. The compression engine is configured to receive the data packets and determine a compressibility of the data included by the data packets based on the memory requests corresponding to the data packets. The compression engine is further configured to control communication of the data packets through an interconnect architecture based on the compressibility.

In some aspects the techniques described herein relate to a system wherein the compression engine determines a classification of each memory request based on respective metadata associated with each memory request, the classification being one of a prefetch classification or a demand classification. The compression engine determines the compressibility based on the classification.

In some aspects the techniques described herein relate to a system wherein the compression engine controls communication of the data packets through the interconnect architecture by compressing data included in data packets that satisfy a condition and bypassing compression of data included in data packets that do not satisfy the condition, where the condition is based on the classification.

In some aspects the techniques described herein relate to a system wherein the compression engine determines the compressibility based on a memory level parallelism (MLP) associated with the memory requests and the MLP is specified by metadata in the memory requests and the data packets.

In some aspects the techniques described herein relate to a method that includes generating, at a hardware prefetcher, metadata associated with a memory request; and a memory request packet including the memory request and the metadata. The method includes executing the memory request from the memory request packet to generate a data packet including the metadata and data retrieved from a physical memory and receiving the data packet at a hardware compression engine. The method further includes determining, by the hardware compression engine, a compressibility of the data in the data packet based on the metadata and controlling communication of the data from the hardware compression engine through an interconnect architecture based on the compressibility.

In some aspects the techniques described herein relate to a method wherein controlling communication of the data from the hardware compression engine through the interconnect architecture based on the compressibility includes: responsive to a content of the metadata satisfying a condition, compressing the data via the hardware compression engine, and responsive to the content not satisfying the condition, bypassing compression of the data.

In some aspects the techniques described herein relate to a method wherein generating the metadata is based on a request history associated with the hardware prefetcher and includes determining, by the hardware prefetcher, a frequency of promotion of prefetch memory requests to demand memory requests described by the request history, comparing, by the hardware prefetcher, the frequency to a threshold frequency, and setting, by the hardware prefetcher, a value of a compression indicator in the metadata based on the comparing.

In some aspects the techniques described herein relate to a method wherein determining the compressibility of the data in the data packet is further based on a memory level parallelism (MLP) associated with the memory request, the MLP specified by the metadata.

In some aspects the techniques described herein relate to a method wherein controlling communication of the data from the hardware compression engine through the interconnect architecture based on the compressibility includes compressing the data via the hardware compression engine and communicating the data from the hardware compression engine through the interconnect architecture to a decompression engine. The method further includes decompressing the data via the decompression engine, and determining, by the decompression engine, an amount by which the data was compressed.

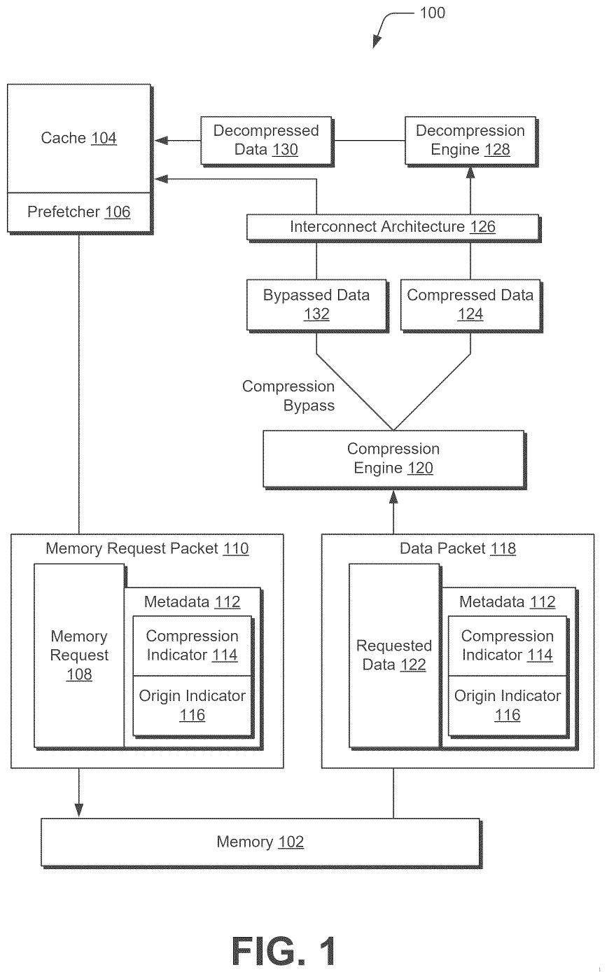

FIG. 1 is a block diagram of a non-limiting example system 100 operable to implement selective data compression for non-critical memory requests. The system 100 is depicted including a memory 102 (also referred to herein as a physical memory) and a cache 104. In accordance with the described techniques, the memory 102 and the cache 104 are coupled to one another via a wired or wireless connection. Example wired connections include, but are not limited to, data communication buses connecting the memory 102 and the cache 104, a network-on-chip, traces, planes, or any type of interconnect that enables transfer of data between the system components described herein. Examples of devices (e.g., computing devices) in which the system 100 is configured for integration include, but are not limited to, servers, personal computers, laptops, desktops, game consoles, etc.

The cache 104 is configured to store data for access by one or more processors. The device may include a plurality of different caches. Generally, caches are located in close proximity to one or more processors that retrieve data from the caches to perform operations associated with various workloads and/or applications (e.g., software).

Each cache may have an associated prefetcher, such as a prefetcher 106 depicted as associated with the cache 104. The prefetcher 106 associated with the cache 104 is configured to generate prefetch requests that are executable to retrieve data from the memory 102 predicted to be used by a workload of one or more processors and load the data to the cache 104. Similarly, prefetchers associated with other caches are configured to retrieve data from the memory 102 for storage to the respective associated caches.

One such prefetch request (also referred to herein as a prefetch memory request) is depicted as a memory request 108 generated by the prefetcher 106. The memory request 108 is included within a memory request packet 110 generated by the prefetcher 106. The memory request packet 110 is communicated from the prefetcher 106 for retrieval of data specified by the memory request 108 from the memory 102. In some implementations, the memory request packet 110 is received and executed by a memory controller, and the memory controller communicates with the memory 102 to retrieve the data specified by the memory request 108 from the memory 102.

The memory request packet 110 additionally includes metadata 112 along with the memory request 108. In the depicted example, the metadata 112 is generated by the prefetcher 106 as part of the generating of the memory request packet 110 and the memory request 108. In some implementations, the metadata 112 is appended to the memory request 108 or otherwise integrated with the memory request 108 (e.g., as bits within the memory request 108 reserved for the metadata 112).

The metadata 112 includes a compression indicator 114 (e.g., the compression indicator 114 is a content of the metadata 112). In some implementations, the compression indicator 114 is a bit or a plurality of bits, with a value of the compression indicator 114 defined by the prefetcher 106. The value of the compression indicator 114 is used to determine whether the data that is associated with the memory request 108 and retrieved from the memory 102 responsive to execution of the memory request 108 is to be compressed as described further below. The compression indicator 114 thus hints as to a compressibility of the data (e.g., a probability that the data is able to be compressed) and also hints to a classification of the memory request associated with the data (e.g., a probability of whether the memory request remains a prefetch request or is promoted to a demand request).

In some situations the value of the compression indicator 114 may be set based on an address of the physical memory associated with the memory request and specified by the memory request. For example, requests to retrieve data from one or more addresses within a first range of addresses of the memory 102 may include the compression indicator 114 set to a first value, while requests to retrieve data from addresses within a second range may include the compression indicator 114 set to a second value.

The metadata 112 is depicted additionally including an origin indicator 116 (e.g., the origin indicator 116 is a content of the metadata 112). The origin indicator 116 may be a bit or a plurality of bits used to indicate an origin of the memory request 108 and the memory request packet 110. The origin refers to the hardware component that generates the memory request 108 and the memory request packet 110 (e.g., prefetcher 106). The origin indicator 116 may additionally specify the type of prefetcher associated with the memory request 108 and/or a core associated with the memory request 108.

Although in the depicted example the memory request 108 is a prefetch request, in some situations the memory request 108 may be a demand request (also referred to as a demand memory request) communicated from a processor associated with the cache 104 and the prefetcher 106. In such situations, the metadata 112 may be specified by the processor instead of the prefetcher 106.

Following execution of the memory request 108, a data packet 118 is generated that is communicated to a compression engine 120. The data packet 118 includes requested data 122 that is retrieved from the memory 102 responsive to execution of the memory request 108. The requested data 122 is thus data from the memory 102 that is specified by the memory request 108. For example, the memory request 108 may specify one or more addresses of the memory 102 for retrieval of the requested data 122 from the specified addresses.

The data packet 118 additionally includes the metadata 112 from the memory request packet 110. In some implementations, the metadata 112 is appended to the requested data 122 or otherwise integrated with the requested data 122. In some implementations, the data packet 118 is generated by the memory controller and is communicated from the memory controller to the compression engine 120.

The compression engine 120 is implemented in hardware of the system 100 (e.g., as an integrated circuit) and includes instructions (e.g., implemented as hardware logic elements such as gates, switches, and so forth) to perform operations relating to compression of data retrieved from the memory 102. In some implementations, the compression engine 120 can be fully pipelined. The compression engine 120 receives the data packet 118 and determines whether the requested data 122 should be compressed based on the metadata 112. If the compression engine 120 determines that the requested data 122 should be compressed, the compression engine 120 compresses the requested data 122 and outputs compressed data 124 to be communicated through interconnect architecture 126 to a decompression engine 128.

The interconnect architecture 126 includes a plurality of interconnects (e.g., conductive connections) that communicatively couple the memory 102 and the memory controller with the cache 104 and one or more processors. The interconnect architecture 126 is arranged between the memory 102 and the cache 104, with the memory 102 at a first side of the interconnect architecture 126 and with the cache 104 and the one or more processors at a second side of the interconnect architecture 126. The interconnect architecture 126 may include various queues such as intra-SOC (system on a chip) link queues for connecting various blocks, interconnect switch queues, memory controller queues, etc.

The decompression engine 128 is implemented in hardware (e.g., as an integrated circuit) and includes instructions (e.g., implemented as hardware logic elements such as gates, switches, and so forth) for decompressing data received through the interconnect architecture 126 from the compression engine 120. In some implementations, the decompression engine 128 can be fully pipelined. The decompression engine 128 receives the compressed data 124 and decompresses the compressed data 124 to output decompressed data 130. The decompressed data 130 is provided from the decompression engine 128 to the cache 104 in accordance with the memory request 108.

In a situation in which the compression engine 120 receives the data packet 118 and determines based on the metadata 112 that the requested data 122 should not be compressed, the compression engine 120 outputs the requested data 122 as bypassed data 132. The bypassed data 132 is communicated through the interconnect architecture 126 to the cache 104 in accordance with the memory request 108. In some implementations, if the compression engine 120 determines that the requested data 122 should not be compressed, the compression engine 120 sets the value of the compression indicator 114 to indicate that the requested data 122 is not compressed. The compression engine 120 may then communicate the requested data 122 along with the compression indicator 114 through the interconnect architecture 126 to the decompression engine 128, and the decompression engine 128 determines that decompression operations should not be performed on the requested data 122 based on the value of the compression indicator 114. The decompression engine 128 may further communicate the requested data 122 to the cache 104.

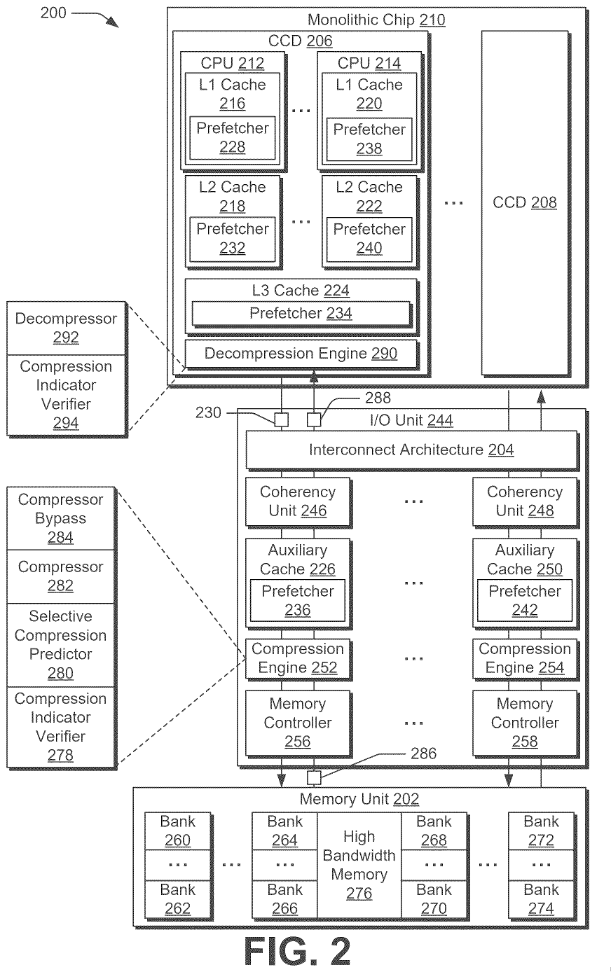

FIG. 2 depicts another non-limiting example system 200 to implement selective data compression for non-critical memory requests. At least some of the components described above with reference to FIG. 1 may be similar to, or the same as, the components depicted by FIG. 2 and may be labeled and/or described similarly. For example, FIG. 2 shows various caches which may be similar to the cache 104, prefetchers which may be similar to the prefetcher 106, etc.

In the implementation shown by FIG. 2, the system 200 includes a plurality of central processing unit (CPU) chiplet dies (CCDs), such as a CCD 206 and a CCD 208. In some implementations, each CCD includes a similar configuration of components. Further, in the depicted example, the CCDs are included as part of a single monolithic chip 210. However, in some implementations, the CCDs are separate from each other and are not joined as a single monolithic chip.

The CCD 206 is depicted as including a plurality of CPUs. In particular, the CCD 206 is shown including a CPU 212 and a CPU 214 each having a similar configuration. However, in some implementations, the CCD 206 may include a different number of CPUs. The CPUs are electronic circuits that read, translate, and execute workloads of a program, e.g., an application, operating system, virtual machine, container, and so on. In some implementations a different type of processing unit may be used (e.g., graphics processing units, field programmable gate arrays, application specific integrated circuits, etc.).

Each CPU is associated with at least one respective cache. In the depicted example, the CPU 212 is associated with level one cache 216 and level two cache 218, while the CPU 214 is associated with level one cache 220 and level two cache 222. The CPUs may retrieve data from the respective associated caches to perform operations related to various workloads and applications executable by the CPUs. For example, the CPU 212 may retrieve data from one or both of the level one cache 216 and the level two cache 218, and the CPU 214 may retrieve data from one or both of the level one cache 220 and the level two cache 222. Each CPU may share a level three cache 224 in some implementations. In some implementations, the number of cache levels may be different (e.g., more cache levels may be included, or fewer cache levels may be included).

The caches may be semiconductor memory where data is stored within memory cells on one or more integrated circuits. The various memory sources are ordered from fastest access speed to slowest access speed in the following order: (1) the level one cache 216, (2) the level two cache 218, (3) the level three cache 224, (4) an auxiliary cache 226, and (5) the memory unit 202. As a result, a CPU of the system 200 (e.g., CPU 212) may progressively check the caches and the memory unit 202 for data in the aforementioned order. If the data is present in a cache, the data is provided from that cache to the CPU, and if not, the next cache or the memory unit 202 is checked for presence of the data.

The level one cache 216 includes a hardware prefetcher 228, which is representative of functionality implemented in the hardware of the CPU 212 to prefetch data that is predicted to be used (e.g., in the near future) by a workload of a runtime program. For example, the hardware prefetcher 228 is an electronic circuit that monitors memory access patterns of the workload and predicts which memory addresses are likely to be accessed based on the observed memory access patterns. The hardware prefetcher 228 issues a prefetch request to fetch data of the predicted memory address from a slower memory source in terms of access speed (e.g., the level two cache 218, the level three cache 224, the auxiliary cache 226, or the memory unit 202) into the level one cache 216. The prefetch request is in the form of a memory request packet 230. The memory request packet 230 is depicted as an example and may have a configuration similar to that of the memory request packet 110 described above. The system 200 is depicted as including various other hardware prefetchers, such as prefetcher 232, prefetcher 234, prefetcher 236, prefetcher 238, prefetcher 240, and prefetcher 242. The various hardware prefetchers may operate in a similar manner as described above with reference to hardware prefetcher 228.

The system 200 further includes an input/output (I/O) unit 244. The I/O unit 244 includes the interconnect architecture 204, a respective coherency unit per CCD (e.g., a coherency unit 246 associated with the CCD 206 and a coherency unit 248 associated with the CCD 208), a respective auxiliary cache per CCD (e.g., an auxiliary cache 226 associated with the CCD 206 and an auxiliary cache 250 associated with the CCD 208), a respective compression engine per CCD (e.g., a compression engine 252 associated with the CCD 206 and a compression engine 254 associated with CCD 208), and a respective memory controller per CCD (e.g., a memory controller 256 associated with CCD 206 and a memory controller 258 associated with CCD 208). Although the I/O unit 244 is depicted as a single unit including the components described above, in some implementations the components may be separate and not integrated with a single I/O unit.

The memory unit 202 is communicatively coupled with the memory controllers to receive memory requests and communicate data stored in the memory unit 202 to the compression engines. The memory controllers may manage the memory unit 202, including the communication of data to and from the memory unit 202 over respective couplings between the memory unit 202 and the memory controllers. The memory controllers may be digital circuits (e.g., implemented in hardware) including logic to read and write to the memory unit 202. The memory unit 202 may include volatile memory and non-volatile memory and stores data for use by the CPUs. For example, the memory unit 202 may include random-access memory (RAM), dynamic random-access memory (DRAM), read-only memory (ROM), programmable read-only memory (PROM), high bandwidth memory (HBM), etc. The memory unit 202 may be a circuit board (e.g., a printed circuit board) on which the volatile memory and the non-volatile memory are mounted. The memory unit 202 is depicted as including various memory banks for storage of data (e.g., bank 260, bank 262, bank 264, bank 266, bank 268, bank 270, bank 272, and bank 274), as well as high bandwidth memory 276. A variety of different configurations of the memory unit 202 are possible without departing from the scope of the described techniques.

In the depicted example, the compression engine 252 and the compression engine 254 have a similar configuration. The compression engine 252 is shown including a compression indicator verifier 278, a selective compression predictor 280, a compressor 282, and a compressor bypass 284. Each of the components of the compression engine 252 may be implemented in hardware and perform operations supporting selective data compression for non-critical memory requests. In particular, the compression engine 252 employs the compression indicator verifier 278 to determine a value of a compression indicator included in metadata of a data packet. An example data packet 286 depicted by FIG. 2 may have a configuration similar to that of the data packet 118 described above. Based on the value of the compression indicator as verified by the compression indicator verifier 278, the compression engine 252 may bypass compression of the data included by the data packet or perform additional operations using the selective compression predictor 280.

As an example, in a situation in which the compression engine 252 receives a compression indicator with a first value (e.g., zero), the compression engine 252 bypasses compression of the data via the compressor bypass 284. However, if the compression indicator has a second value (e.g., one), the compression engine 252 may perform additional checks via the selective compression predictor 280 to confirm whether the data should indeed be compressed using compressor 282. The compressor 282 is implemented in hardware and may include various logic elements (e.g., gates, switches, etc.) to compress data and output the compressed data for communication through the interconnect architecture 204. The data output by the compression engine 252 is depicted by output data 288, which is representative of both compressed data (e.g., compressed data 124) and uncompressed data (e.g., bypassed data 132) output by the compression engine 252.

The compression engine 252 can be implemented in hardware and connected to each of the memory controller 256 and the coherency unit 246 via scalable data ports, intra-SOC links, etc. In some implementations, the compression engine 252 may be a separate module (e.g., a separate integrated circuit) positioned on top of (or alongside) the CCD 206 and/or the memory unit 202.

The metadata included in memory request packets can be configured to specify a different granularity depending on the predictor table entry bits (e.g., historical compressibility data stored in one or more tables) present in the compression engine. For example, instead of a given origin indicator specifying a particular prefetcher, the origin indicator may specify a CCD including multiple prefetchers (e.g., CCD 206).

Compressed data is received by the decompression engine 290, and the decompression engine 290 employs a decompressor 292 to decompress the received data. In the depicted example, the decompression engine 290 includes compression indicator verifier 294 configured to detect whether data received by the decompression engine 290 is compressed or uncompressed. For example, following compression of data via the compressor 282 as described above, the compression indicator verifier 294 may read the value of the compression indicator in order to determine that the data received by the decompression engine 290 is compressed. The decompression engine 290 may accordingly decompress the data prior to providing the data to a cache (e.g., level three cache 224, level two cache 218, etc.) or a CPU (e.g., the CPU 212).

Various example situations are described below involving operations performed by the compression engine 252 and the decompression engine 290. Although the compression engine 252 is described by way of example, similar operations may be performed by the compression engine 254 (and other similar compression engines in some implementations). Further, although the CCD 206 is described by way of example, similar operations may be performed by CCD 208 or other CCDs.

In an example situation, the hardware prefetchers included by the CCD 206 can set compression indicators associated with memory requests to indicate that the data associated with the memory requests should not be compressed. This can occur responsive to determining that prefetch requests associated with the prefetchers are frequently being promoted to demand requests (e.g., a frequency of promotion for a given prefetcher exceeds a threshold frequency). In the compression engine, based on the history of compressibility of prefetched data by a specific prefetcher from a particular CCD, hints can be issued to not compress data provided to the cache or CPU associated with the prefetcher. For example, if the data is stored in a particular memory region (e.g. banks of the memory unit 202 in which the data is stored) and data from that region has historically been not compressible, this could indicate that the data within the memory region is encrypted. The selective compression predictor 280 of the compression engine 252 may therefore recognize encrypted data and bypass compression of the encrypted data to conserve resources (e.g., power that would have been used to attempt compression).

In some circumstances, the selective compression predictor 280 may further adjust the value of the compression indicator associated with incompressible data (e.g., encrypted data) to indicate that the data was not compressible. The selective compression predictor 280 may communicate the data through the interconnect architecture 204 to a cache or processor along with the compression indicator having the adjusted value. A processor and/or prefetcher may then refer to the adjusted compression indicator when generating subsequent memory request packets and may set the values of compression indicators of the packets accordingly to avoid attempting to compress incompressible data.

An origin indicator in the metadata may specify a prefetcher issuing the prefetch request, along with the corresponding CPU and/or CCD number associated with the prefetcher. The compression engine 252 tracks the compressibility for requests from a given origin specified by an origin indicator using predictor tables present in the selective compression predictor 280. If one or more requests from a given origin do not compress, then the compressor may stop compressing requests from that origin (e.g., requests that have the same origin indicator) for a pre-determined duration or number of requests.

In some situations, the system can expose model-specific registers (MSRs) using the metadata included in memory request packets to control compressibility of certain type of requests. For example, memory regions containing encrypted data may be indicated through software and identified by the metadata using the MSRs. As another example, an instruction in an instruction set architecture (ISA) may indicate to not compress data associated with a request and may disable compression for data from a specific memory region.

In some situations, the system 200 tracks a percentage of prefetch requests that are converted to demand requests. The tracking may be implemented as tables stored at the prefetchers in some implementations. If the percentage of converted requests from a given prefetcher (or CCD) is higher than a threshold (where each prefetcher and CCD may have different thresholds), then future requests from that prefetcher (or CCD) may not be compressed.

In an example operation, the selective compression predictor 280 is employed to determine whether an override condition is present responsive to receiving a data packet. The override condition may be based on a historical compressibility (also referred to herein as a compressibility history) of data associated with memory requests from a particular prefetcher or CCD specified by an origin indicator in the metadata of the data packet (e.g., the origin indicator 116).

If the override condition is satisfied, compression of the data is bypassed via the compressor bypass 284. This may include adjusting the value of the compression indicator (e.g., to indicate that the data is not compressed) and including the compression indicator with the data communicated through the interconnect architecture 204. However, if the override condition is not satisfied, the compressor 282 compresses the data and communicates the data through interconnect architecture 204 to the corresponding cache associated with the prefetcher or CPU. Based on the compressibility of the data, prefetcher predictor tables in the selective compression predictor 280 may be updated to guide whether the data in future data packets including similar metadata should be compressed or not compressed.

The selective compression predictor 280 is also employed to determine whether data should be compressed based on a memory level parallelism (MLP) associated with the memory request packet communicated for retrieval of the data. For example, the MLP in application phases may be highly repeatable such that when a memory request from a given origin (e.g., a prefetcher) is determined to have a high MLP, the selective compression predictor 280 can predict that other requests from the same origin will also have a high MLP. Accordingly, the MLP associated with a memory request can be tracked via the metadata to provide hints to the selective compression predictor 280 for determining whether data should be compressed. The MLP may be specified in the origin indicator included by the metadata, in some implementations.

As an example, the compression engine 252 may receive a data packet with metadata specifying the MLP associated with the memory request from which the data packet is generated. If the selective compression predictor 280 determines that the MLP is greater than a threshold MLP, the selective compression predictor 280 may provide the data to compressor 282 for compression even if a compression indicator included in the metadata indicates that the data should not be compressed.

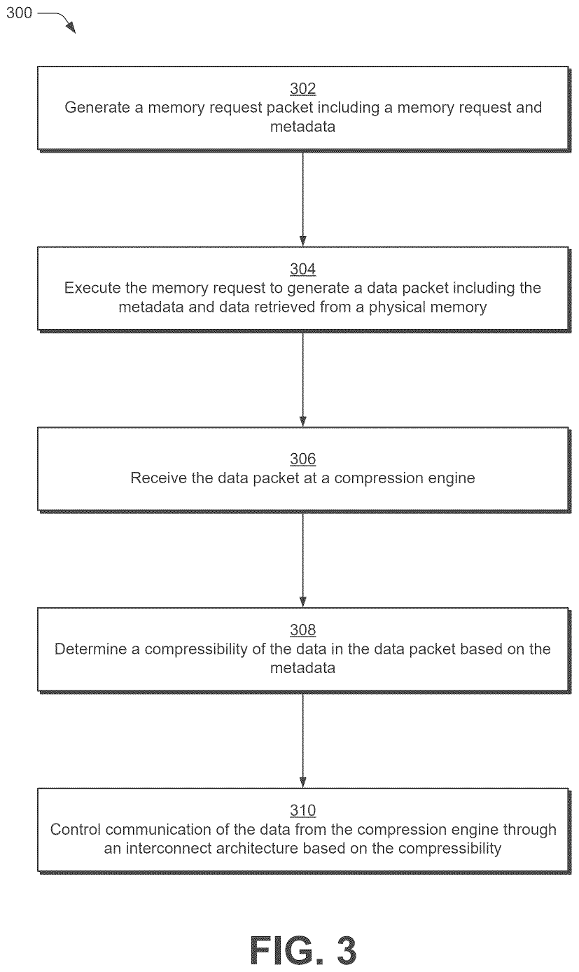

FIG. 3 depicts a procedure 300 in an example implementation of selective data compression for non-critical memory requests. The procedures described herein may be implemented using the systems described above, e.g., the system 100 and/or the system 200. However, the systems described above are non-limiting examples of systems that may be employed to perform the procedures described below.

A memory request packet including a memory request and metadata is generated (block 302). By way of example, memory request packet 110 is generated by prefetcher 106, where the memory request packet 110 includes the memory request 108 and the metadata 112.

The memory request is executed to generate a data packet including the metadata and data retrieved from a physical memory (block 304). By way of example, the memory request packet 110 is communicated to the memory 102 or a memory controller associated with the memory 102 (e.g., the memory controller 256), and the memory request 108 is executed by the memory 102 or the memory controller to generate the data packet 118 including the requested data 122 and the metadata 112.

The data packet is received at a compression engine (block 306). By way of example, the data packet 118 is communicated from the memory 102 or the memory controller to the compression engine 120.

A compressibility of the data in the data packet is determined based on the metadata (block 308). By way of example, the compression engine 120 evaluates the compression indicator 114 via a compression indicator verifier (e.g., compression indicator verifier 278). Based on the value of the compression indicator 114, the compression engine 120 makes an initial determination as to whether the requested data 122 should be compressed or should not be compressed.

The compression engine 120 may additionally evaluate a content of the origin indicator 116 to determine whether the compression indicator 114 should be overridden. For example, if the compression indicator 114 indicates that the requested data 122 should not be compressed, the compression engine 120 may employ selective compression predictor 280 to determine whether the requested data 122 should instead be compressed based on the information included in the origin indicator 116. The determination may include, for example, comparing an MLP associated with the memory request packet 110 to a threshold MLP, and/or comparing a historical compressibility of data associated with memory requests generated by the prefetcher 106 to a threshold compressibility based on one or more historical compressibility tables stored at the compression engine 120.

Communication of the data from the compression engine through an interconnect architecture is controlled based on the compressibility (block 310). By way of example, if the compression engine 120 determines that the requested data 122 should be compressed, the compression engine 120 compresses the data and communicates the compressed data 124 through the interconnect architecture 126 to the decompression engine 128. However, if the compression engine 120 determines that compression of the requested data 122 should be bypassed, the compression engine 120 outputs the requested data 122 as the bypassed data 132 which is communicated through the interconnect architecture 126 to the cache 104.

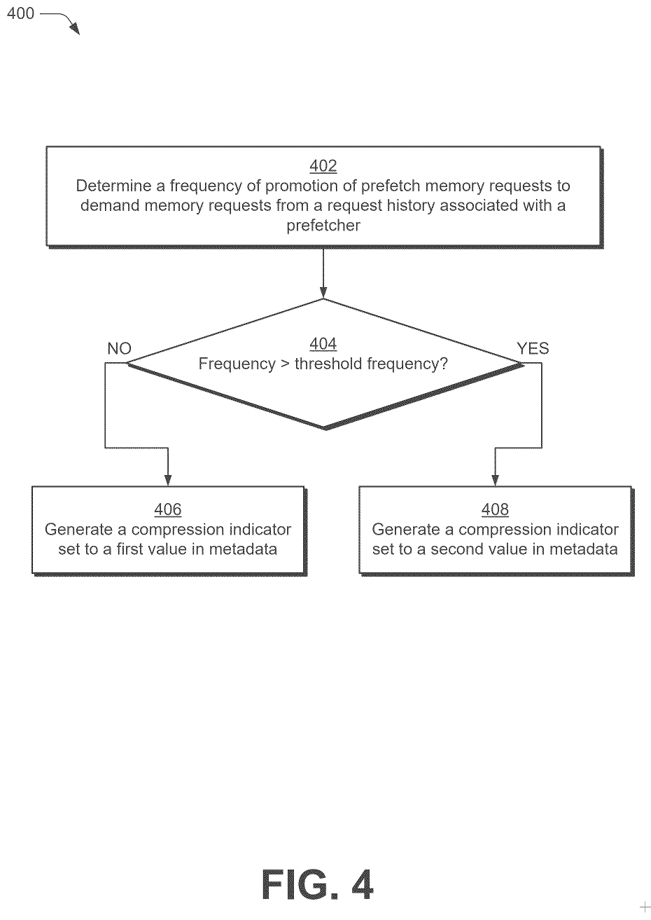

FIG. 4 depicts a procedure 400 in an example implementation of generating a compression indicator for selective data compression for non-critical memory requests. A frequency of promotion of prefetch memory requests to demand memory requests is determined from a request history associated with a prefetcher (block 402). By way of example, the prefetcher 106 maintains one or more request history tables that describe outcomes of previous memory requests generated by the prefetcher 106. The outcomes may include, for example, whether particular memory requests that were generated as prefetch requests were promoted to demand requests prior to receiving the data specified by the prefetch requests at the cache 104. The prefetcher 106 determines the frequency at which prefetch requests are promoted to demand requests based on entries in the one or more request history tables.

As an example of promotion of a prefetch request to a demand request, the memory request 108 may be configured as a prefetch request. During the process of retrieving data based on the memory request 108 and communicating the data as described above, one or more processors (e.g., similar to the CPU 212) communicatively coupled to the cache 104 may execute instructions that would utilize the data if the data were already in the cache 104. However, as the data is in the process of being retrieved and communicated to the cache 104 responsive to the prefetch request, the data is unavailable to the processor until the prefetch request is completed. The processor thus may designate the prefetch request as being a demand request (e.g., promote the prefetch request to a demand request), indicating that the retrieved data is for immediate use by the processor rather than predicted use. The promotion may be recorded to the one or more request history tables for future reference.

A determination is made as to whether the frequency is greater than a threshold frequency (block 404). By way of example, the prefetcher 106 compares the determined frequency to a threshold frequency. In one non-limiting example, the threshold frequency corresponds to ninety percent of prefetch requests being promoted to demand requests.

If the frequency is not greater than the threshold frequency, a compression indicator set to a first value is generated in metadata (block 406). By way of example, the compression indicator 114 may be generated with a value equal to one indicating that the data associated with the memory request 108 should be compressed. The determined frequency of promotion of prefetch requests being lower than the threshold may indicate that a likelihood of additional prefetch requests being promoted to demand requests is low.

If the frequency is greater than the threshold frequency, a compression indicator set to a second value is generated in metadata (block 408). By way of example, the compression indicator 114 may be generated with a value equal to zero. The value of “zero” may indicate to the compression engine 120 that the data associated with the memory request 108 should not be compressed (e.g., compression of the requested data 122 should be bypassed).

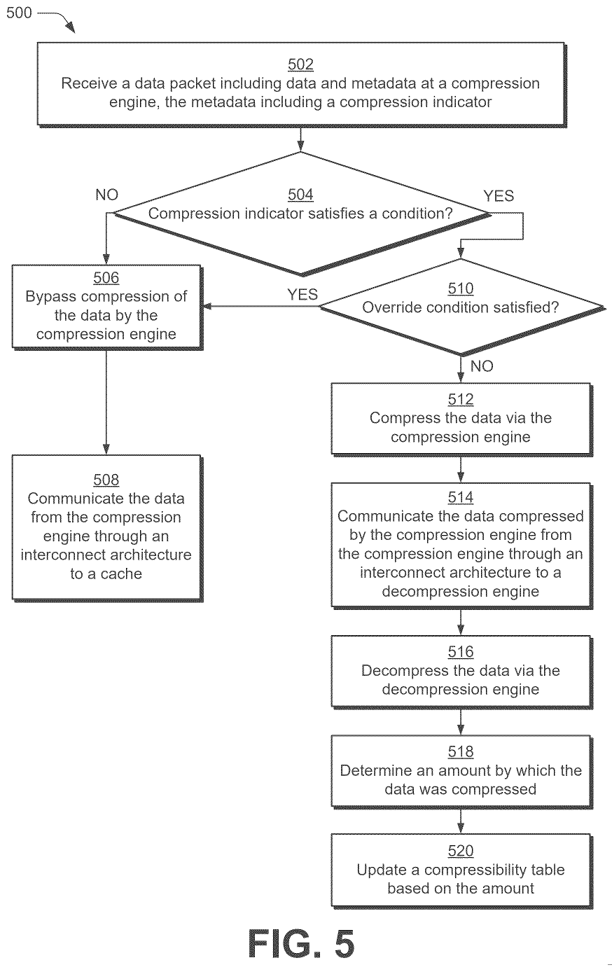

FIG. 5 depicts a procedure 500 in an example implementation of compressing or bypassing data via a compression engine for selective data compression for non-critical memory requests. A data packet including data and metadata is received at a compression engine, the metadata including a compression indicator (block 502). By way of example, the data packet 118 is received at the compression engine 120, where the data packet 118 includes the requested data 122 and the metadata 112.

A determination is made as to whether the compression indicator satisfies a condition (block 504). By way of example, a compression indicator verifier of the compression engine 120 reads the value of the compression indicator 114, with a first value satisfying the condition and a second value (and/or other values) not satisfying the condition. The condition may thus be based on the classification of a memory request associated with the data packet (e.g., prefetch requests associated with the first value and demand requests associated with the second value).

If the compression indicator does not satisfy the condition, compression of the data by the compression engine is bypassed (block 506). By way of example, the compression engine 120 outputs the requested data 122 as bypassed data 132, where the bypassed data 132 is the requested data 122 that has not been compressed by the compression engine 120.

The bypassed data is communicated from the compression engine through an interconnect architecture to a cache (block 508). By way of example, the bypassed data 132 is communicated through interconnect architecture 126 to the cache 104.

However, if the compression indicator satisfies the condition, a determination is made as to whether an override condition is satisfied (block 510). By way of example, a selective compression predictor of the compression engine 120 determines a historical compressibility of data retrieved responsive to requests from the prefetcher 106, where the prefetcher 106 is identified by the origin indicator 116. Data describing the historical compressibility may be stored in one or more tables at the compression engine 120. Satisfaction of the override condition may include determining that the historical compressibility is higher than a threshold compressibility, where the threshold compressibility may be pre-determined (e.g., set at a time of manufacture of the system 100) and/or user defined (e.g., via a user interface).

If the override condition is satisfied, the compression of the data is bypassed as described above. By way of example, the requested data 122 is communicated through the interconnect architecture 126 as bypassed data 132.

If the override condition is not satisfied, the data is compressed via the compression engine (block 512). By way of example, the compression engine 120 compresses the requested data 122 via a compressor implemented in hardware (e.g., similar to the compressor 282).

The data compressed by the compression engine is communicated from the compression engine through an interconnect architecture to a decompression engine (block 514). By way of example, the compressed data 124 is communicated through interconnect architecture 126 to the decompression engine 128.

The data is decompressed via the decompression engine (block 516). By way of example, the decompression engine 128 employs a decompressor implemented in hardware to decompress the compressed data 124 (e.g., similar to the decompressor 292).

An amount by which the data was compressed is determined (block 518). By way of example, the decompression engine 128 determines the amount by which the compressed data 124 is decompressed by comparing the compressed data 124 to the decompressed data 130.

A compressibility table is updated based on the amount (block 520). By way of example, the compressibility table is maintained by the cache 104 and/or the prefetcher 106, and updating the compressibility table includes generating an entry in the compressibility table describing the amount determined by comparing the compressed data 124 to the decompressed data 130.

In some scenarios, the selective compression predictor of the compression engine 120 may override the compression indicator 114. For example, the selective compression predictor may determine based on an MLP described by the origin indicator 116 that the requested data 122 should be compressed, e.g., when the MLP is greater than a threshold MLP. Compression of data based on the MLP may occur even in instances in which the memory request packet 110 is for a demand request, as the high MLP indicates that the data may be compressed without causing delays in operation of the processor that receives the data.

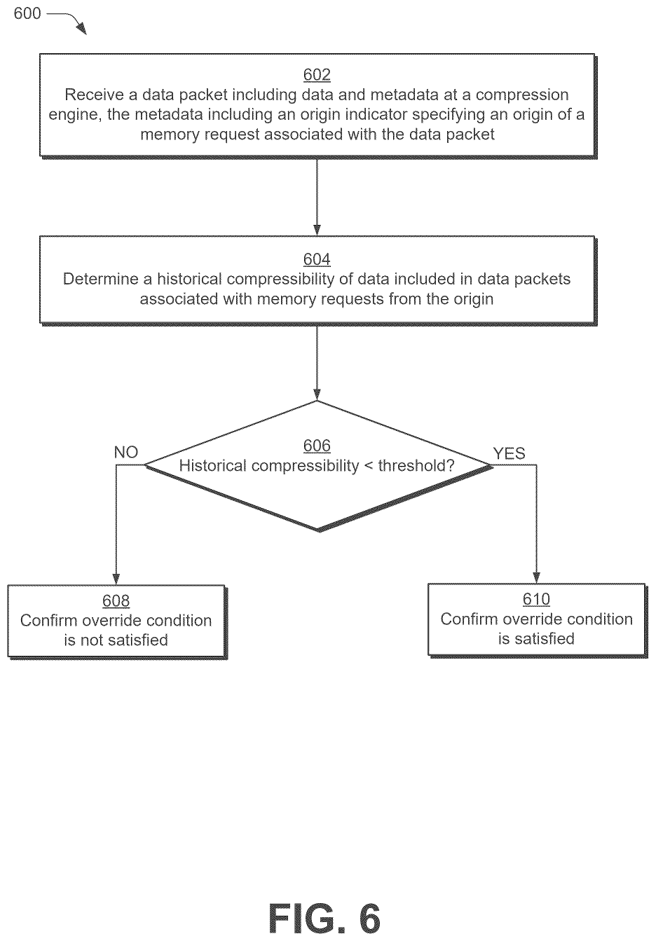

FIG. 6 depicts a procedure 600 in an example implementation of utilizing a historical compressibility of data for selective data compression for non-critical memory requests.

A data packet is received including data and metadata at a compression engine, the metadata including an origin indicator specifying an origin of a memory request associated with the data packet (block 602). By way of example, the data packet 118 including the requested data 122 and the metadata 112 is received at the compression engine 120. The metadata 112 includes the origin indicator 116 specifying the origin of the memory request 108 as the prefetcher 106.

A historical compressibility of data included in data packets associated with memory requests from the origin is determined (block 604). By way of example, the historical compressibility is determined using one or more tables maintained by the compression engine 120.

A determination is made as to whether the historical compressibility is less than a threshold (block 606). By way of example, the historical compressibility may be expressed as a percentage of requests from the prefetcher 106 that resulted in compressible data. For example, although the compression indicator 114 may have the value set to “one” for a given request to indicate to the compression engine 120 that the data associated with the request should be compressed, in some situations the compression engine 120 attempts to compress the data and the data is unchanged by the compression. In particular, encrypted data retrieved from the memory 102 is likely to have low compressibility or no compressibility due to randomness of the data introduced by one or more encryption algorithms.

Therefore, while compression of encrypted data may be attempted, the data output by the compressor may be identical to the encrypted data input to the compressor. The compression engine 120 may record the result of the compression (e.g., the compressibility of the data) to the one or more tables. If the historical compressibility of data associated with requests from the prefetcher 106 is low, this may indicate that the prefetcher 106 often generates requests for encrypted data. The historical compressibility may thus be utilized by the selective compression predictor 280 to determine whether data compression should be attempted when data packets associated with requests from the prefetcher 106 are received. As one non-limiting example, the historical compressibility for the prefetcher 106 may be fifty percent (e.g., fifty percent of requests from the prefetcher 106 being associated with compressible data), and the threshold compressibility may be eighty percent.

If the historical compressibility is not less than the threshold, an override condition is confirmed to be not satisfied (block 608). By way of example, the compression indicator 114 indicates that the requested data 122 should be compressed by the compression engine 120, and the selective compression predictor determines that the override condition is not satisfied based on the historical compressibility. Thus, the compression engine 120 does not override the instruction to compress the requested data 122 as indicated by the compression indicator 114.

However, if the historical compressibility is less than the threshold, the override condition is confirmed to be satisfied (block 610). By way of example, the compression indicator 114 indicates that the requested data 122 should be compressed by the compression engine 120, and the selective compression predictor determines that the override condition is satisfied based on the historical compressibility. As a result, the compression of the data is bypassed, thereby avoiding expending time and resources attempting to compress data that is likely incompressible (e.g., encrypted data).

It should be understood that many variations are possible based on the disclosure herein. Although features and elements are described above in particular combinations, each feature or element is usable alone without the other features and elements or in various combinations with or without other features and elements.

The procedure 300, the procedure 400, the procedure 500, and the procedure 600 are shown as operations (or actions) performed, but are not necessarily limited to the order or combinations in which the operations are shown herein. Any one or more operations may be repeated, combined, or reorganized to provide other algorithms. In portions of the described above, reference may be made to the systems and components of FIGS. 1 and 2, reference to which is made by example. The algorithms are not limited to performance by the mentioned systems and components.

In one or more implementations, the methods and procedures provided herein are implemented in a computer program, software, or firmware incorporated in a non-transitory computer-readable storage medium for execution by a general purpose computer or a processor.

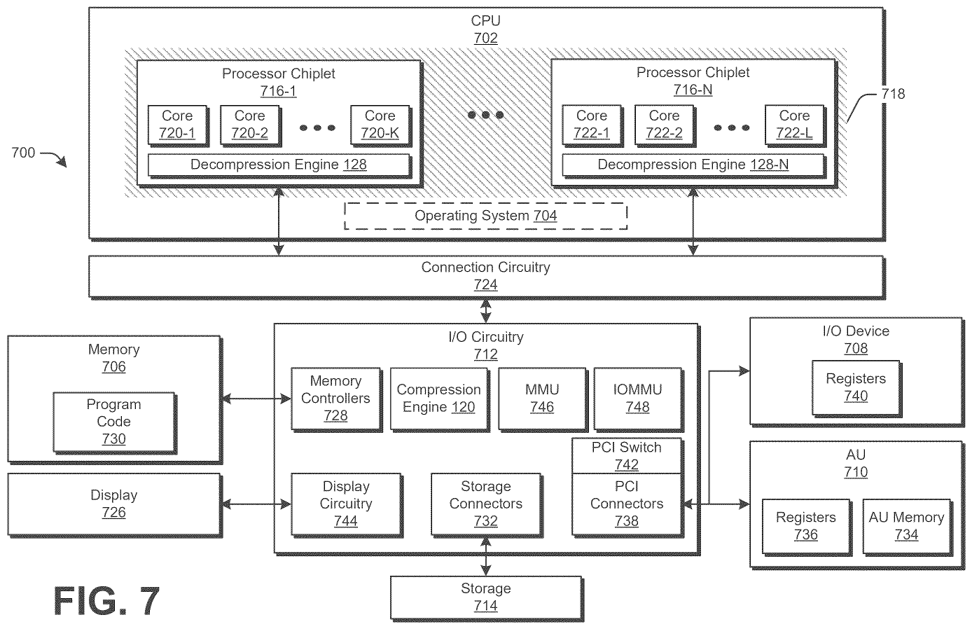

FIG. 7 is a block diagram of a processing system configured to execute one or more applications, in accordance with one or more implementations.

FIG. 7 includes a processing system 700 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 700 includes a central processing unit (CPU) 702. In one or more implementations, the CPU 702 is configured to run an operating system (OS) 704 that manages the execution of applications. For example, the OS 704 is configured to schedule the execution of tasks (e.g., instructions) for applications, allocate portions of resources (e.g., system memory 706, CPU 702, input/output (I/O) device 708, accelerator unit (AU) 710, storage 714) for the execution of tasks for the applications, provide an interface to I/O devices (e.g., I/O device 708) for the applications, or any combination thereof.

In this example, the compression engine 120 is depicted in the I/O circuitry 712. In variations, however, the compression engine 120 is included in and/or is implemented by one or more different components of the processing system 700, such as the CPU 702, the memory 706, the I/O device 708, the AU 710, the storage 714, and so forth. In at least one implementation, the compression engine 120 or portions of the compression engine 120 are included in at least two of the depicted components of the processing system 700. By way of example, the compression engine 120 may be included in or otherwise implemented by at least the memory 706 and the I/O device 708. Further, the decompression engine 128 is depicted in a processor chiplet 716-1 (with each of one or more processor chiplets including a corresponding decompression engine as indicated by decompression engine 128-N of processor chiplet 716-N). In variations, however, each decompression engine (e.g., decompression engine 128) is included in and/or is implemented by one or more different components of the processing system. In some implementations, the decompression engines or portions of the decompression engines are included in at least two of the depicted components of the processing system 700.

The CPU 702 includes the one or more processor chiplets 716-1 through 716-N, which are communicatively coupled together by a data fabric 718 in one or more implementations.

Each of the processor chiplets 716-1 through 716-N, for example, includes one or more processor cores (e.g., 720-1 through 720-K and 722-1 through 722-L, respectively) configured to concurrently execute one or more series of instructions, also referred to herein as “threads,” for an application. Further, the data fabric 718 communicatively couples each processor chiplet 716-N of the CPU 702 such that each processor core (e.g., processor cores 720-1 through 720-K) of a first processor chiplet (e.g., 716-1) is communicatively coupled to each processor core (e.g., processor cores 722-1 through 722-L) of one or more other processor chiplets (e.g., processor chiplet 716-N). Though the example embodiment presented in FIG. 7 shows a first processor chiplet (716-1) having three processor cores (720-1, 720-2, 720-K) representing a K number of processor cores and a second processor chiplet (716-N) having three processor cores (e.g., 722-1, 722-2, 722-L) representing an L number of processor cores, in other implementations (L being an integer number greater than or equal to one), each processor chiplet 716-1 through 716-N may have any number of processor cores. For example, processor chiplet 716-1 can have the same number of processor cores as one or more other processor chiplets (e.g., 716-N), a different number of processor cores as one or more other processor chiplets, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 700, the CPU 702 is communicatively coupled to an I/O circuitry 712 by a connection circuitry 724. For example, each processor chiplet 716-1 through 716-N of the CPU 702 is communicatively coupled to the I/O circuitry 712 by the connection circuitry 724. The connection circuitry 724 includes, for example, one or more data fabrics, buses, buffers, queues, and the like. The I/O circuitry 712 is configured to facilitate communications between two or more components of the processing system 700 such as between the CPU 702, system memory 706, display 726, universal serial bus (USB) devices, peripheral component interconnect (PCI) devices (e.g., I/O device 708, AU 710), storage 714, and the like.

As an example, system memory 706 includes any combination of one or more volatile memories and/or one or more non-volatile memories, examples of which include dynamic random-access memory (DRAM), static random-access memory (SRAM), non-volatile RAM, and the like. To manage access to the system memory 706 by CPU 702, the I/O device 708, the AU 710, and/or any other components, the I/O circuitry 712 includes one or more memory controllers 728. These memory controllers 728, for example, include circuitry configured to manage and fulfill memory access requests issued from the CPU 702, the I/O device 708, the AU 710, or any combination thereof. Examples of such requests include read requests, write requests, fetch requests, pre-fetch requests, or any combination thereof. That is to say, these memory controllers 728 are configured to manage access to the data stored at one or more memory addresses within the system memory 706, such as by CPU 702, the I/O device 708, and/or the AU 710.

When an application is to be executed by processing system 700, the OS 704 running on the CPU 702 is configured to load at least a portion of program code 730 (e.g., an executable file) associated with the application from, for example, a storage 714 into system memory 706. This storage 714, for example, includes a non-volatile storage such as a flash memory, solid-state memory, hard disk, optical disc, or the like configured to store program code 730 for one or more applications.

To facilitate communication between the storage 714 and other components of processing system 700, the I/O circuitry 712 includes one or more storage connectors 732 (e.g., universal serial bus (USB) connectors, serial AT attachment (SATA) connectors, PCI Express (PCIe) connectors) configured to communicatively couple storage 714 to the I/O circuitry 712 such that I/O circuitry 712 is capable of routing signals to and from the storage 714 to one or more other components of the processing system 700.

In association with executing an application, in one or more scenarios, the CPU 702 is configured to issue one or more instructions (e.g., threads) to be executed for an application to the AU 710. The AU 710 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 710 includes one or more compute units that concurrently execute one or more threads of an application and store data resulting from the execution of these threads in AU memory 734. This AU memory 734, for example, includes any combination of one or more volatile memories and/or non-volatile memories, examples of which include caches, video RAM (VRAM), or the like. In one or more implementations, these compute units are also configured to execute these threads based on the data stored in one or more physical registers 736 of the AU 710.

To facilitate communication between the AU 710 and one or more other components of processing system 700, the I/O circuitry 712 includes or is otherwise connected to one or more connectors, such as PCI connectors 738 (e.g., PCIe connectors) each including circuitry configured to communicatively couple the AU 710 to the I/O circuitry such that the I/O circuitry 712 is capable of routing signals to and from the AU 710 to one or more other components of the processing system 700. Further, the PCIe connectors 738 are configured to communicatively couple the I/O device 708 to the I/O circuitry 712 such that the I/O circuitry 712 is capable of routing signals to and from the I/O device 708 to one or more other components of the processing system 700.

By way of example and not limitation, the I/O device 708 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 708 is configured to execute one or more operations, tasks, instructions, or any combination thereof based on one or more physical registers 740 of the I/O device 708. In one or more implementations, such physical registers 740 are configured to maintain data (e.g., operands, instructions, values, variables) indicating one or more operations, tasks, or instructions to be performed by the I/O device 708.

To manage communication between components of the processing system 700 (e.g., AU 710, I/O device 708) that are connected to PCI connectors 738, and one or more other components of the processing system 700, the I/O circuitry 712 includes PCI switch 742. The PCI switch 742, for example, includes circuitry configured to route packets to and from the components of the processing system 700 connected to the PCI connectors 738 as well as to the other components of the processing system 700. As an example, based on address data indicated in a packet received from a first component (e.g., CPU 702), the PCI switch 742 routes the packet to a corresponding component (e.g., AU 710) connected to the PCI connectors 738.

Based on the processing system 700 executing a graphics application, for instance, the CPU 702, the AU 710, or both are configured to execute one or more instructions (e.g., draw calls) such that a scene including one or more graphics objects is rendered. After rendering such a scene, the processing system 700 stores the scene in the storage 714, displays the scene on the display 726, or both. The display 726, for example, includes a cathode-ray tube (CRT) display, liquid crystal display (LCD), light emitting diode (LED) display, organic light emitting diode (OLED) display, or any combination thereof. To enable the processing system 700 to display a scene on the display 726, the I/O circuitry 712 includes display circuitry 744. The display circuitry 744, for example, includes high-definition multimedia interface (HDMI) connectors, DisplayPort connectors, digital visual interface (DVI) connectors, USB connectors, and the like, each including circuitry configured to communicatively couple the display 726 to the I/O circuitry 712. Additionally or alternatively, the display circuitry 744 includes circuitry configured to manage the display of one or more scenes on the display 726 such as display controllers, buffers, memory, or any combination thereof.

Further, the CPU 702, the AU 710, or both are configured to concurrently run one or more virtual machines (VMs), which are each configured to execute one or more corresponding applications. To manage communications between such VMs and the underlying resources of the processing system 700, such as any one or more components of processing system 700, including the CPU 702, the I/O device 708, the AU 710, and the system memory 706, the I/O circuitry 712 includes memory management unit (MMU) 746 and input-output memory management unit (IOMMU) 748. The MMU 746 includes, for example, circuitry configured to manage memory requests, such as from the CPU 702 to the system memory 706. For example, the MMU 746 is configured to handle memory requests issued from the CPU 702 and associated with a VM running on the CPU 702. These memory requests, for example, request access to read, write, fetch, or pre-fetch data residing at one or more virtual addresses (e.g., guest virtual addresses) each indicating one or more portions (e.g., physical memory addresses) of the system memory 706. Based on receiving a memory request from the CPU 702, the MMU 746 is configured to translate the virtual address indicated in the memory request to a physical address in the system memory 706 and to fulfill the request. The IOMMU 748 includes, for example, circuitry configured to manage memory requests (memory-mapped I/O (MMIO) requests) from the CPU 702 to the I/O device 708, the AU 710, or both, and to manage memory requests (direct memory access (DMA) requests) from the I/O device 708 or the AU 710 to the system memory 706. For example, to access the registers 740 of the I/O device 708, the registers 736 of the AU 710, and/or the AU memory 734, the CPU 702 issues one or more MMIO requests. Such MMIO requests each request access to read, write, fetch, or pre-fetch data residing at one or more virtual addresses (e.g., guest virtual addresses) which each represent at least a portion of the registers 740 of the I/O device 708, the registers 736 of the AU 710, or the AU memory 734, respectively. As another example, to access the system memory 706 without using the CPU 702, the I/O device 708, the AU 710, or both are configured to issue one or more DMA requests. Such DMA requests each request access to read, write, fetch, or pre-fetch data residing at one or more virtual addresses (e.g., device virtual addresses) which each represent at least a portion of the system memory 706. Based on receiving an MMIO request or DMA request, the IOMMU 748 is configured to translate the virtual address indicated in the MMIO or DMA request to a physical address and fulfill the request.

In variations, the processing system 700 can include any combination of the components depicted and described. For example, in at least one variation, the processing system 700 does not include one or more of the components depicted and described in relation to FIG. 7. Additionally or alternatively, in at least one variation, the processing system 700 includes additional and/or different components from those depicted. The processing system 700 is configurable in a variety of ways with different combinations of components in accordance with the described techniques.

What is claimed is:

1. A computing device comprising:
a cache;
a hardware prefetcher associated with the cache configured to:
generate a memory request packet including a memory request and metadata associated with the memory request;
a memory controller configured to communicate a data packet to a hardware compression engine responsive to execution of the memory request, the data packet including the metadata and data retrieved from a physical memory; and
the hardware compression engine configured to receive the data packet and control communication of the data through an interconnect architecture based on a compressibility of the data.

2. The computing device of claim 1, wherein the hardware compression engine is further configured to:
compress the data responsive to detecting that a condition of the metadata has been satisfied; and
bypass compression of the data responsive to detecting that the condition has not been satisfied.

3. The computing device of claim 2, wherein the hardware compression engine is configured to bypass compression of the data by communicating the data through the interconnect architecture to the cache associated with the hardware prefetcher without compressing the data.

4. The computing device of claim 2, wherein the hardware compression engine is configured to communicate the compressed data through the interconnect architecture to a decompression engine.

5. The computing device of claim 1, wherein the hardware prefetcher generates the metadata based on a request history associated with the hardware prefetcher, the request history describing prefetch memory requests promoted to demand memory requests, and the hardware prefetcher is configured to:
compare a frequency of promotion of the prefetch memory requests to demand memory requests to a threshold frequency, the frequency of promotion based on the request history; and
set a value of a compression indicator in the metadata based on a difference between the frequency and the threshold frequency.

6. The computing device of claim 1, wherein the hardware compression engine is configured to compress the data based on the compressibility; and further comprising a decompression engine separated from the hardware compression engine by the interconnect architecture, the decompression engine configured to:
receive the data compressed by the hardware compression engine; and
decompress the data.

7. The computing device of claim 6, wherein a compressibility history associated with the hardware prefetcher is updated based on an amount by which the data was compressed.

8. The computing device of claim 1, wherein the compressibility is based on a memory level parallelism (MLP) associated with the memory request and described by the metadata.

9. The computing device of claim 1, wherein the memory request is a prefetch memory request generated by the hardware prefetcher for the cache.

10. The computing device of claim 1, wherein the compressibility of the data is based on historical compressibility data associated with memory requests from the hardware prefetcher.

11. The computing device of claim 1, wherein the hardware prefetcher generates the metadata based on an address of the physical memory associated with the memory request and specified by the memory request.

12. A system, comprising:
a physical memory;
a memory controller in communication with the physical memory, the memory controller configured to receive memory requests and generate data packets including data retrieved from the physical memory based on the memory requests; and
a compression engine in communication with the memory controller, the compression engine configured to:
receive the data packets; and
control communication of the data packets through an interconnect architecture based on a compressibility of the data included by the data packets.

13. The system of claim 12, wherein a classification of each memory request is based on respective metadata associated with each memory request, the classification being one of a prefetch classification or a demand classification, and the compressibility is based on the classification.

14. The system of claim 13, wherein the compression engine controls communication of the data packets through the interconnect architecture by compressing data included in data packets that satisfy a condition and bypassing compression of data included in data packets that do not satisfy the condition, where the condition is based on the classification.

15. The system of claim 12, wherein the compressibility is based on a memory level parallelism (MLP) associated with the memory requests, and the MLP is specified by metadata in the memory requests and the data packets.

16. A method, comprising:
generating, at a hardware prefetcher, a memory request packet including a memory request and metadata associated with the memory request;
executing the memory request from the memory request packet to generate a data packet including the metadata and data retrieved from a physical memory;
receiving the data packet at a hardware compression engine; and
controlling communication of the data from the hardware compression engine through an interconnect architecture based on a compressibility of the data in the data packet.

17. The method of claim 16, wherein controlling communication of the data from the hardware compression engine through the interconnect architecture based on the compressibility includes:
responsive to a content of the metadata satisfying a condition, compressing the data via the hardware compression engine; and
responsive to the content not satisfying the condition, bypassing compression of the data.

18. The method of claim 16, wherein generating the metadata is based on a request history associated with the hardware prefetcher and includes:
comparing, by the hardware prefetcher, a frequency of promotion of prefetch memory requests to demand requests to a threshold frequency, the frequency of promotion described by the request history; and
setting, by the hardware prefetcher, a value of a compression indicator in the metadata based on the comparing.

19. The method of claim 16, wherein the compressibility of the data in the data packet is based on a memory level parallelism (MLP) associated with the memory request, the MLP specified by the metadata.

20. The method of claim 16, wherein controlling communication of the data from the hardware compression engine through the interconnect architecture based on the compressibility includes compressing the data via the hardware compression engine and communicating the data from the hardware compression engine through the interconnect architecture to a decompression engine; and further comprising:
decompressing the data via the decompression engine according to an amount by which the data was compressed.
